(19) United States
(12) Patent Application Publication
(10) Pub. No.: US 2026/0025050 A1
(43) Pub. Date: Jan. 22, 2026

(54) THIN LINEAR MOTOR KIT

(71) Applicant: Primax Electronics Ltd., Taipei (TW)

(72) Inventors: Wei-Chiang Huang, Taipei (TW); Wei-Ping Chan, Taipei (TW); Tse-Ping Kuan, Taipei (TW); Ming-Hui Yeh, Taipei (TW)

(21) Appl. No.: 18/799,258

(22) Filed: Aug. 9, 2024

(30) Foreign Application Priority Data
Jul. 18, 2024 (TW) 113126907

(51) Int. Cl. H02K 33/18; H02K 3/26

(52) U.S. Cl. CPC H02K 33/18; H02K 3/26; H02K 2203/03

(57) ABSTRACT

A thin linear motor kit includes a magnet module, a support base, two swinging elements and a coil module. The magnet module is installed on the support base. Each of the two swinging elements includes two fixed ends and at least one coupling end. The two fixed ends are connected with a circuit mechanism. The at least one coupling end is connected with the support base. The coil module is located under the magnet module. When the coil module is activated to drive the support base, the magnet module and the support base are vibrated quickly back and forth along the Y-axis direction.

### FIELD OF THE INVENTION

The present invention relates to the field of a vibration motor technology, and more particularly to a linear motor kit for a consumer electronic product.

### BACKGROUND OF THE INVENTION

With the development of technology, consumer electronic products are becoming more and more popular and gradually favored by people. For example, consumer electronic products include remote control handles of game consoles, handheld game consoles, mobile phones, navigation devices or handheld electronic devices. Generally, in these consumer electronic products, a linear motor is used to generate vibration to increase the feedback during the user’s operation. For example, the linear motor is used to generate incoming call prompts on mobile phones, touch or press prompts on touch panels, navigation prompts, vibration prompts on remote control handles of game consoles, or the like.

In accordance with the existing technologies, linear motors are usually vibrated back and forth in the horizontal direction (i.e., the X-axis direction). However, when the operating habits of users and the market trends of consumer electronic products are taken into consideration, the demands for linear motors that can be vibrated back and forth in the vertical direction (i.e., the Y-axis direction) are gradually increasing. In accordance with a concept of designing an electronic product, the purpose of vibrating the linear motor back and forth in the vertical direction is achieved by changing the placement direction of the electronic product.

Since the width of the existing linear motor in the horizontal direction (i.e., the X-axis direction) is usually greater than the height of the linear motor in the vertical direction (i.e., the Y-axis direction), the change of the placement direction of the linear motor usually causes the change of the original internal circuit of the electronic product. In other words, the flexibilities of the component placement and the circuit design are reduced. Moreover, since the space required for the installation of the linear motor increases, it is difficult to achieve the purpose of making the electronic device thinner.

In order to overcome the drawbacks of the conventional technologies, it is important to provide a linear motor capable of generating vibration in the vertical direction while narrowing or reducing the size in the Y-axis direction.

### SUMMARY OF THE INVENTION

The present invention provides a thin linear motor kit capable of quickly generating vibration in the Y-axis direction while effectively narrowing or reducing the size of thin linear motor kit in the Y-axis direction.

In accordance with an aspect of the present invention, a thin linear motor kit includes a magnet module, a support base, two swinging elements and a coil module. The magnet module is installed on the support base. Each of the two swinging elements includes two fixed ends and at least one coupling end. The two fixed ends are connected with a circuit mechanism. The at least one coupling end is connected with the support base. The coil module is located under the magnet module. When the coil module is activated to drive the magnet module, the magnet module and the support base are vibrated quickly back and forth along a first direction through the two swinging elements. The first direction is a Y-axis direction.

In an embodiment, the two swinging elements are two swinging arms. The swinging arms and the support base are collaboratively formed as a supporting frame. The two swinging arms are respectively located beside two opposite sides of the support base. Each of the two swinging arms is perpendicular or substantially perpendicular to the first direction and includes the two fixed ends and the coupling end. The two fixed ends are opposed to each other. The coupling end is arranged between the two fixed ends.

In an embodiment, the thin linear motor kit further includes two counterweights. The two counterweights are opposed to each other and arranged on the support base along a second direction.

In an embodiment, the support base includes two protrusion ear structures, and the two protrusion ear structures are bent from two opposite sides of the support base and extended along the second direction. The two counterweights are respectively fixed on the two protrusion ear structures.

In an embodiment, the coil module includes at least one coil and a flexible circuit board. The at least one coil is disposed on the flexible circuit board, and the at least one coil faces the magnet module.

In an embodiment, the thin linear motor kit further includes a bottom plate, and the bottom plate is arranged between the magnet module and the coil module. The bottom plate includes two end parts and an avoidance opening. The two end parts are opposed to each other. The avoidance opening is aligned with the at least one coil of the coil module. The two end parts are connected with the circuit mechanism. The avoidance opening is aligned with the at least one coil. The at least one coil is disposed within the avoidance opening.

In an embodiment, the two fixed ends of each swinging arm are respectively fixed on the two end parts of the bottom plate.

In an embodiment, the thin linear motor kit further includes an adhesive layer. The adhesive layer is disposed on the circuit mechanism. The flexible circuit board of the coil module and the two end parts of the bottom plate are adhered on the adhesive layer.

In an embodiment, the support base is a covering member with an accommodation space. An entrance of the accommodation recess faces downwardly. The magnet module is fixed in the accommodation recess.

In an embodiment, one of the two swinging elements includes two first elastic elements, and the other of the two swinging elements includes two second elastic elements. Each of the first elastic elements and the second elastic elements has a coupling end and a fixed end opposed to the coupling end. The two first elastic elements and the two second elastic elements are respectively located at four corners of the accommodation recess. Each of the two first elastic elements and the two second elastic elements is connected with a top side of the accommodation recess through the corresponding coupling end.

In an embodiment, the thin linear motor kit further includes a lower cover. The lower cover is fixed on the circuit mechanism. Each of the first elastic elements and the second elastic elements is connected with the lower cover through the corresponding fixed end.

In an embodiment, the coil module is disposed on the lower cover.

In an embodiment, the coil module includes a flexible circuit board and at least one coil. The at least one coil is disposed on the flexible circuit board and faces the magnet module. The flexible circuit board is attached on the lower cover.

In an embodiment, the thin linear motor kit further includes an adhesive layer. The adhesive layer is disposed on the circuit mechanism. The lower cover is adhered on the adhesive layer.

In an embodiment, each of the first elastic elements and the second elastic elements is made of epoxy resin.

In an embodiment, the magnet module is a Halbach array magnet module. The Halbach array magnet module includes at least three permanent magnets. The at least three permanent magnets are arranged along the first direction.

From the above descriptions, the present invention provides the thin linear motor kit. In the thin linear motor kit, a swinging arm integrally formed with the support base is regarded as the swinging element, or two elastic elements are collaboratively defined as the swinging element. Due to the arrangement of the swinging element, the number of parts to be assembled will be reduced. Consequently, assembling difficulty and the manufacturing cost of the thin linear motor kit will be reduced, and the production yield will be increased. Regardless of whether the swinging arms are perpendicular or substantially perpendicular to the first direction or the elastic elements are used as the swinging element, the size of the thin linear motor kit in the Y-axis direction can be effectively reduced or narrowed. Consequently, the flexibilities of the component placement and the circuit design can be enhanced or maintained, and the purpose of manufacturing the slim electronic device can be achieved.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view of a thin linear motor kit according to a first embodiment of the of the present invention;

FIG. 2A is a schematic three-dimensional exploded view illustrating the thin linear motor kit of the first embodiment and taken along a viewpoint;

FIG. 2B is a schematic three-dimensional exploded view illustrating the thin linear motor kit of the first embodiment and taken along another viewpoint;

FIG. 2C is a schematic cross-sectional view illustrating a Halbach array magnet module in the thin linear motor kit of FIG. 2A and taken along the line A-A’;

FIG. 3 schematically illustrates the operation of the thin linear motor kit according to the first embodiment of the of the present invention;

FIG. 4 is a schematic perspective view of a thin linear motor kit according to a second embodiment of the of the present invention;

FIG. 5A is a schematic three-dimensional exploded view illustrating the thin linear motor kit of the second embodiment and taken along a viewpoint;

FIG. 5B is a schematic three-dimensional exploded view illustrating the thin linear motor kit of the second embodiment and taken along another viewpoint; and

FIG. 6 schematically illustrates the operation of the thin linear motor kit according to the second embodiment of the of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

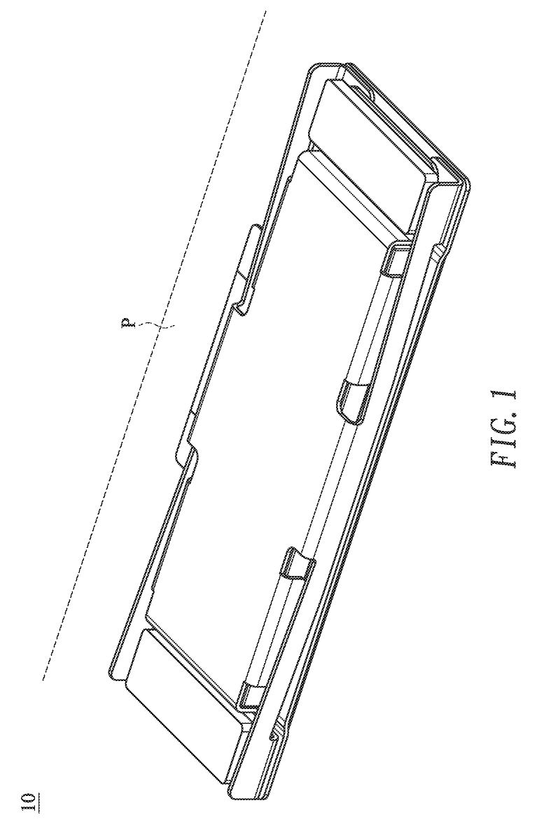

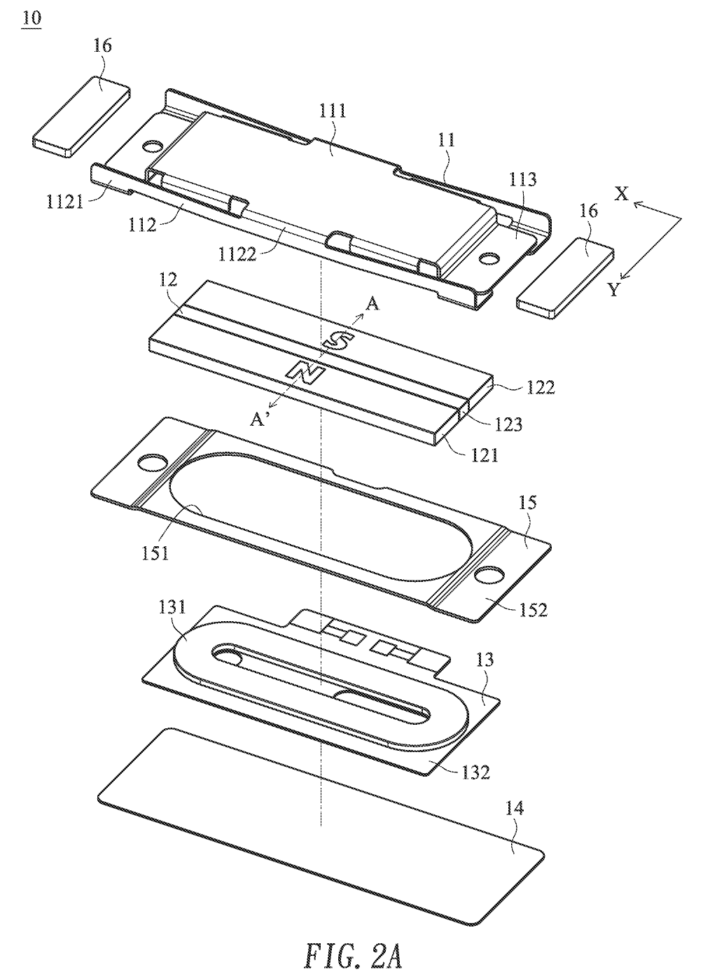

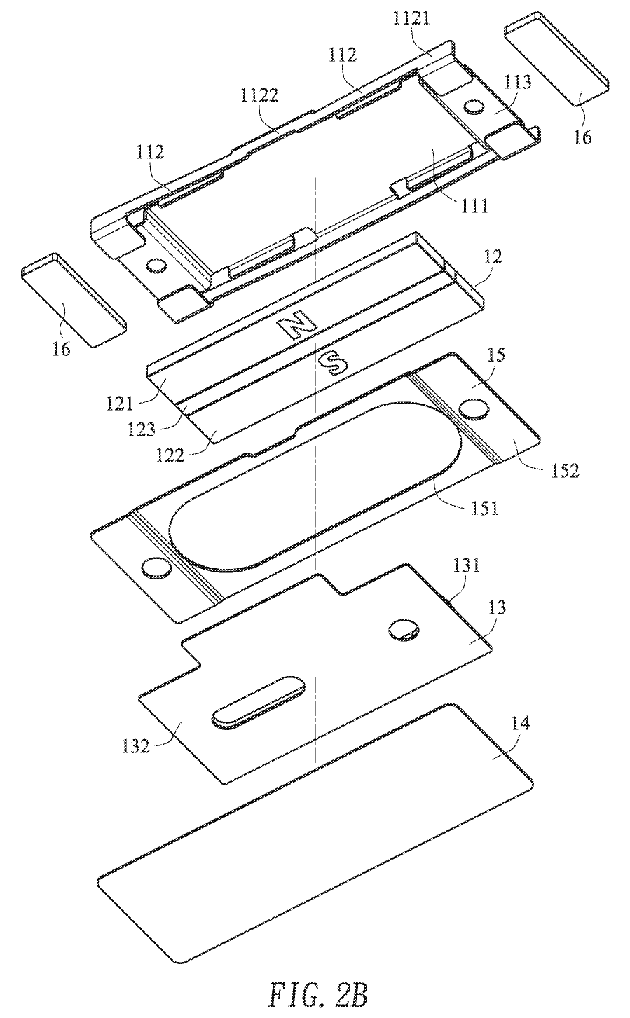

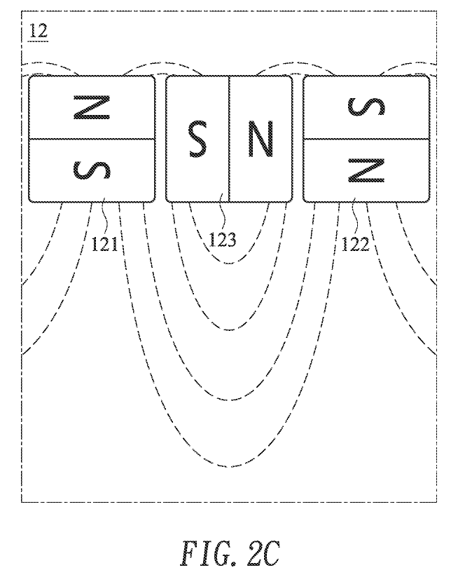

Please refer to FIGS. 1, 2A, 2B and 2C. FIG. 1 is a schematic perspective view of a thin linear motor kit according to a first embodiment of the of the present invention. FIG. 2A is a schematic three-dimensional exploded view illustrating the thin linear motor kit of the first embodiment and taken along a viewpoint. FIG. 2B is a schematic three-dimensional exploded view illustrating the thin linear motor kit of the first embodiment and taken along another viewpoint. FIG. 2C is a schematic cross-sectional view illustrating a Halbach array magnet module in the thin linear motor kit of FIG. 2A and taken along the line A-A’.

As shown in FIG. 1, the thin linear motor assembly 10 is installed on a circuit mechanism P of a fixed or portable electronic device (not shown). For example, the circuit mechanism P is a circuit board, a touch panel or any other motor module with power supply and signal transmission functions.

The thin linear motor kit 10 includes a supporting frame 11, a Halbach array magnet module 12, a coil module 13, an adhesive layer 14, a bottom plate 15 and two counterweights 16. For facilitating illustration, the Y-axis direction is referred as a first direction Y, and the X-axis direction perpendicular to the Y-axis direction is referred as a second direction X.

The supporting frame 11 includes two swinging arms 112 and a support base 111. The two swinging arms 112 are respectively located beside two opposite sides of the support base 111. In addition, the two swinging arms 112 are perpendicular or substantially perpendicular to the first direction Y.

Each of the two swinging arms 112 includes two fixed ends 1121 and a coupling end 1122. The two fixed ends 1121 are opposed to each other. The coupling end 1122 is arranged between the two fixed ends 1121. In an embodiment, each swinging arms 11 is integrally formed with the corresponding long side of the support base 111 through the corresponding coupling end 1122 in the middle site. The fixed ends 1121 can be directly or indirectly connected with the circuit mechanism P shown in FIG. 1. That is, the two swinging arms 112 can be used as swinging elements. Consequently, when a force is applied to the support base 111, the support base 111 can be vibrated back and forth along the first direction Y. Furthermore, the support base 111 includes two protrusion ear structures 113. The two protrusion ear structures 113 are bent from two opposite sides of the support base 111 and extended along the second direction X.

The Halbach array magnet module 12 can be installed in the support base 111 in a gluing manner, an attaching manner or an engaging manner. In an embodiment, the Halbach array magnet module 12 includes permanent magnets 121, 122 and 123. The permanent magnets 121, 122 and 123 are arranged sequentially along the first direction Y. Please refer to FIG. 2C. The permanent magnet 123 is arranged between the permanent magnet 121 and the permanent magnet 122. The N pole of the permanent magnet 121 is located at the upward side. The S pole of the permanent magnet 121 is located at the downward side. The S pole of the permanent magnet 122 is located at the upward side. The N pole of the permanent magnet 122 is located at the downward side. The S pole of the permanent magnet 123 is connected with the permanent magnet 121. The N pole of the permanent magnet 123 is connected with the permanent magnet 122. Due to this structural design, an extremely strong magnetic field (e.g., the magnetic field lines represented by dotted lines) can be formed on the bottom side of the Halbach array magnet module 12, and almost no magnetic field is generated on the top side of the Halbach array magnet module 12.

In the above embodiment, the magnet module is the Halbach array magnet module. It is noted that the magnet module is not restricted to the Halbach array magnet module. As long as similar functions or efficacies can be achieved, the implementation examples of the magnet module are not restricted.

The coil module 13 is located under the Halbach array magnet module 12. In an embodiment, the coil module 13 includes a coil 131 and a flexible circuit board 132. The coil 131 is disposed on the flexible circuit board 132. In addition, the coil 131 faces the bottom side of the Halbach array magnet module 12 with the extremely strong magnetic field. For example, the coil 131 is a physical coil. Alternatively, the coil 131 is a printed coil that is directly printed on the flexible circuit board 132.

The adhesive layer 14 is disposed on the circuit mechanism P (see FIG. 1). Furthermore, the coil module 13 is adhered on the flexible circuit board 132 through the adhesive layer 14. Consequently, the coil module 13 is fixed on the circuit mechanism P.

The bottom plate 15 is arranged between the Halbach array magnet module 12 and the coil module 13. The bottom plate 15 has two end parts 152 and an avoidance opening 151. The two end parts 152 are opposed to each other. The avoidance opening 151 is aligned with the coil 131 of the coil module 13.

In an embodiment, the fixed ends 1121 of the swinging arm 112 are fixed on first surfaces of the corresponding end parts 152 of the bottom plate 15 in a gluing manner, an engaging manner or a screwing manner. The second surfaces of the end parts 152 of the bottom plate 15 are opposed to the first surfaces of the end parts 152 and adhered on the adhesive layer 14. The bottom plate 15 is combined with the circuit mechanism P shown in FIG. 1 through the adhesive layer 14. Furthermore, when the bottom plate 15 is combined with the circuit mechanism P, the coil 131 of the coil module 13 is exposed to the avoidance opening 151 of the bottom plate 15. The two counterweights 16 are opposed to each other and arranged on the support base 111 along the second direction X. In this embodiment, the two counterweights 16 are respectively fixed on the two protrusion ear structures 113 that are extended from two opposite sides of the support base 111.

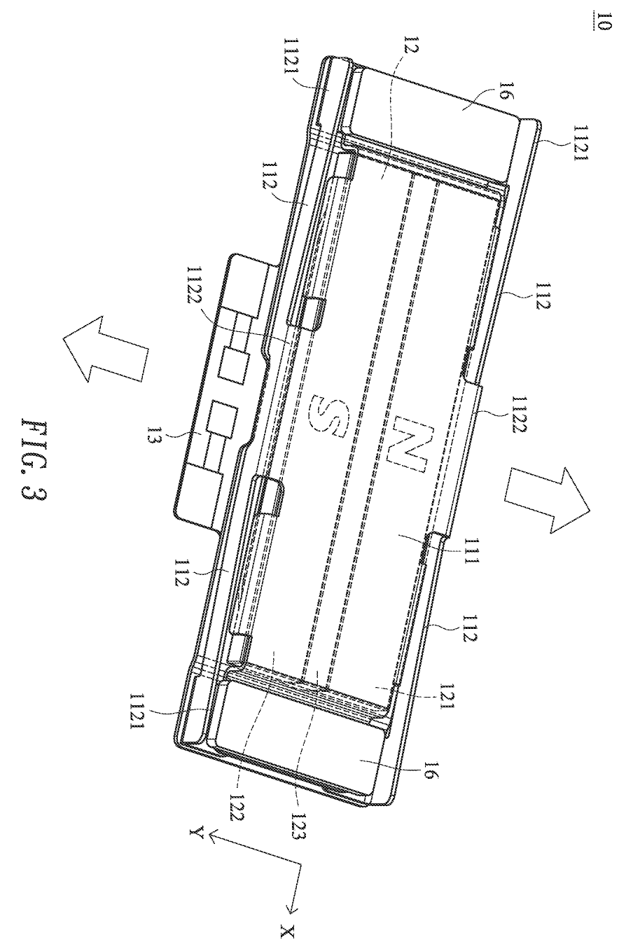

Please refer to FIG. 3. FIG. 3 schematically illustrates the operation of the thin linear motor kit according to the first embodiment of the of the present invention. When the coil module 13 (see FIG. 2A) under the Halbach array magnet module 12 is activated, the support base 111 is driven by the Halbach array magnet module 12. Correspondingly, the Halbach array magnet module 12 and the support base 111 are vibrated quickly back and forth along the first direction Y through the two swinging arms 112. Furthermore, due to the arrangement of the counterweights 16, the kinetic energy for vibrating the Halbach array magnet module 12 and the support base 111 back and forth will be increased. Consequently, the vibration performance of the electronic device with the thin linear motor kit 10 will be further enhanced.

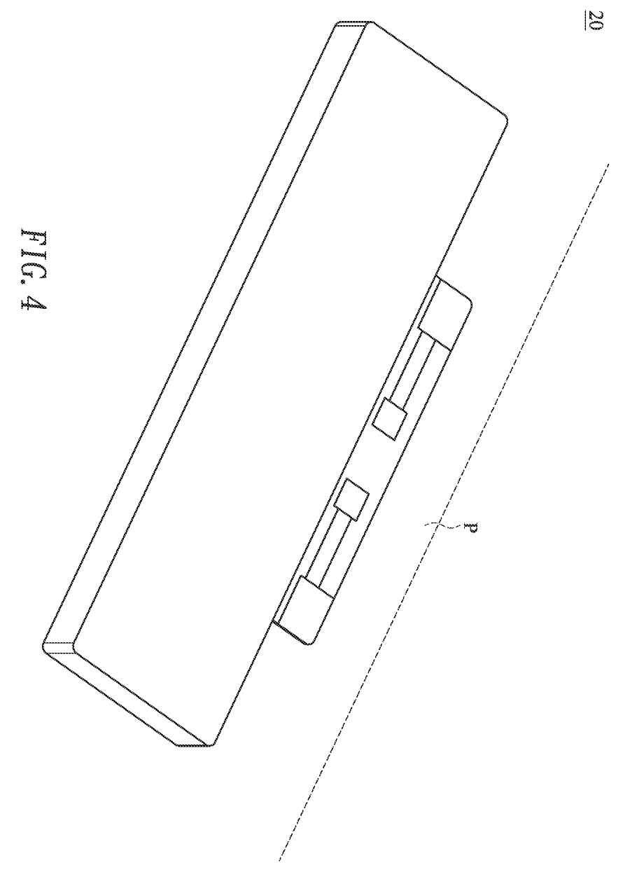

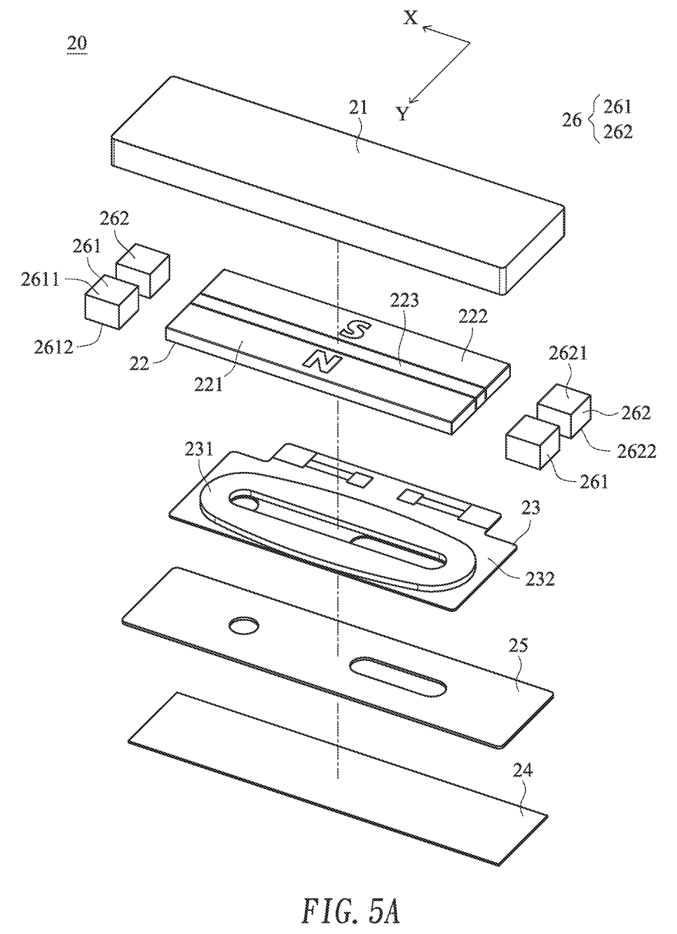

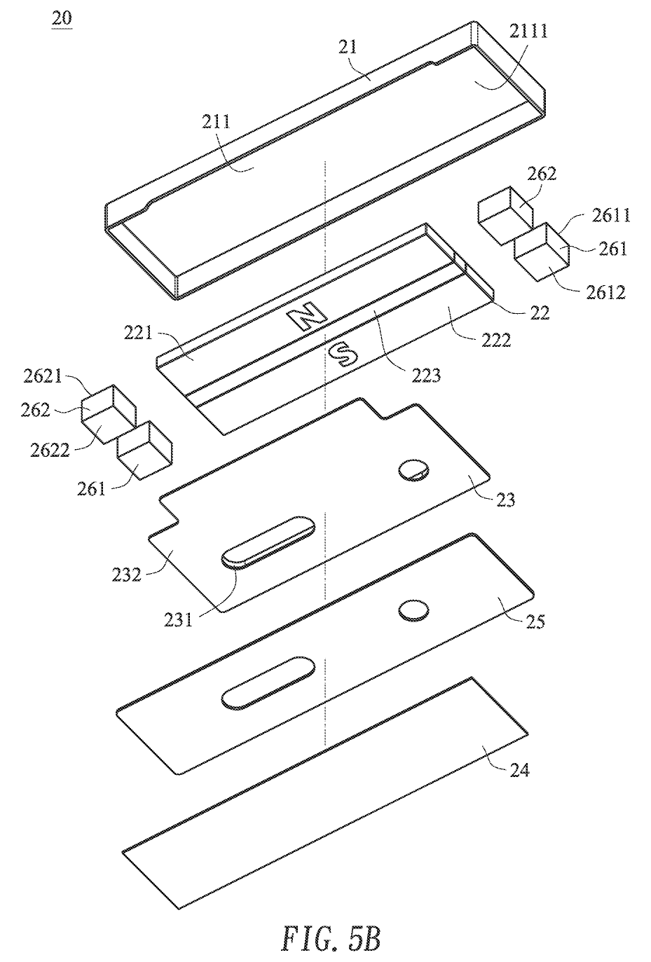

Please refer to FIGS. 4, 5A and 5B. FIG. 4 is a schematic perspective view of a thin linear motor kit according to a second embodiment of the of the present invention. FIG. 5A is a schematic three-dimensional exploded view illustrating the thin linear motor kit of the second embodiment and taken along a viewpoint. FIG. 5B is a schematic three-dimensional exploded view illustrating the thin linear motor kit of the second embodiment and taken along another viewpoint.

As shown in FIG. 4, the thin linear motor assembly 20 is installed on a circuit mechanism P of a fixed or portable electronic device (not shown). For example, the circuit mechanism P is a circuit board, a touch panel or any other motor module with power supply and signal transmission functions.

The thin linear motor kit 20 includes a covering member 21, a Halbach array magnet module 22, a coil module 23, an adhesive layer 24, a lower cover 25 and plural elastic elements 26. The Halbach array magnet module 22 (including permanent magnets 221, 222 and 223), the coil module 23 and the adhesive layer 24 are respectively identical to the Halbach array magnet module 12, the coil module 13 and the adhesive layer 14 shown in FIGS. 2A and 2B, and not redundantly described herein.

In this embodiment, the covering member 21 is a support base. The covering member 21 includes an accommodation recess 211. The entrance of the accommodation recess 211 faces downwardly. In addition, the accommodation recess 211 has a top side 2111. The Halbach array magnet module 22 can be fixed in the accommodation recess 211 in a gluing manner, an attaching manner or an engaging manner.

In an embodiment, the plural elastic elements 26 includes two first elastic elements 261 and two second elastic elements 262. Each of the first elastic elements 261 has a coupling end 2611 and a fixed end 2612, which are opposed to each other. Each of the second elastic elements 262 has a coupling end 2621 and a fixed end 2622, which are opposed to each other. In addition, the two first elastic elements 261 and the two second elastic elements 262 are respectively located at four corners of the accommodation recess 211. The two first elastic elements 261 and the two second elastic elements 262 are connected with the top side 2111 of the accommodation recess 211 through the coupling ends 2611 and 2621. The fixed ends 2612 and 2622 can be directly or indirectly connected with the circuit mechanism P shown in FIG. 4.

In this embodiment, every pair of corresponding elastic elements may be regarded as a swinging element. For example, the two first elastic elements 261 arranged along the first direction Y are collaboratively defined as a swinging element. Alternatively, one first elastic element 261 and one corresponding second elastic element 262 arranged along the second direction X are collaboratively defined as a swinging element. For example, the first elastic elements 261 and the second elastic elements 262 are made of epoxy resin.

The lower cover 25 can be fixed on the circuit mechanism P shown in FIG. 4. In this embodiment, the coil module 23 is disposed on the lower cover 25, and the first elastic elements 261 and the second elastic elements 262 are connected with the lower cover 25 through the fixed ends 2612 and 2622 in an adhering manner or an attaching manner. Furthermore, the lower cover 25 is adhered on the adhesive layer 24. Consequently, the thin linear motor kit 20 as a whole is fixed on the circuit mechanism P.

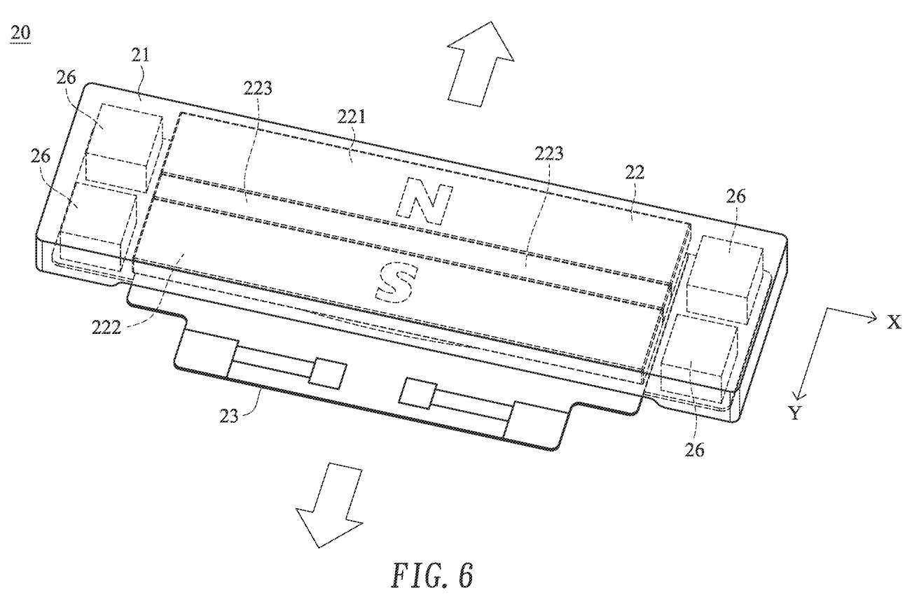

Please refer to FIG. 6. FIG. 6 schematically illustrates the operation of the thin linear motor kit according to the second embodiment of the of the present invention. When the coil module 23 (see FIG. 2A) under the Halbach array magnet module 22 is activated, the covering member 21 is driven by the Halbach array magnet module 22. Correspondingly, the Halbach array magnet module 22 and the covering member 21 are vibrated quickly back and forth along the first direction Y through the elastic elements 26.

From the above descriptions, the present invention provides the thin linear motor kit. The thin linear motor kit is applied to a fixed or portable electronic device or an electronic device with a touch control function. In the thin linear motor kit, a swinging arm integrally formed with the support base is regarded as the swinging element, or two elastic elements are collaboratively defined as the swinging element. Due to the arrangement of the swinging element, the number of parts to be assembled will be reduced. Consequently, assembling difficulty and the manufacturing cost of the thin linear motor kit will be reduced, and the production yield will be increased. Regardless of whether the swinging arms are perpendicular or substantially perpendicular to the first direction or the elastic elements are used as the swinging element, the size of the thin linear motor kit in the Y-axis direction can be effectively reduced or narrowed. Consequently, the flexibilities of the component placement and the circuit design can be enhanced or maintained, and the purpose of manufacturing the slim electronic device can be achieved. In other words, the technologies of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A thin linear motor kit, comprising:
a magnet module;
a support base, wherein the magnet module is installed on the support base;
two swinging elements, wherein each of the two swinging elements comprises two fixed ends and at least one coupling end, the two fixed ends are connected with a circuit mechanism, and the at least one coupling end is connected with the support base; and
a coil module located under the magnet module,
wherein when the coil module is activated to drive the magnet module, the magnet module and the support base are vibrated quickly back and forth along a first direction through the two swinging elements, wherein the first direction is a Y-axis direction.

2. The thin linear motor kit according to claim 1, wherein the two swinging elements are two swinging arms, wherein the swinging arms and the support base are collaboratively formed as a supporting frame, and the two swinging arms are respectively located beside two opposite sides of the support base, wherein each of the two swinging arms is perpendicular or substantially perpendicular to the first direction and comprises the two fixed ends and the coupling end, wherein the two fixed ends are opposed to each other, and the coupling end is arranged between the two fixed ends.

3. The thin linear motor kit according to claim 1, wherein the thin linear motor kit further comprises two counterweights, wherein the two counterweights are opposed to each other and arranged on the support base along a second direction.

4. The thin linear motor kit according to claim 3, wherein the support base comprises two protrusion ear structures, and the two protrusion ear structures are bent from two opposite sides of the support base and extended along the second direction, wherein the two counterweights are respectively fixed on the two protrusion ear structures.

5. The thin linear motor kit according to claim 2, wherein the coil module comprises at least one coil and a flexible circuit board, wherein the at least one coil is disposed on the flexible circuit board, and the at least one coil faces the magnet module.

6. The thin linear motor kit according to claim 5, wherein the thin linear motor kit further comprises a bottom plate, and the bottom plate is arranged between the magnet module and the coil module, wherein the bottom plate comprises two end parts and an avoidance opening, the two end parts are opposed to each other, the avoidance opening is aligned with the at least one coil of the coil module, wherein the two end parts are connected with the circuit mechanism, the avoidance opening is aligned with the at least one coil, and the at least one coil is disposed within the avoidance opening.

7. The thin linear motor kit according to claim 6, wherein the two fixed ends of each swinging arm are respectively fixed on the two end parts of the bottom plate.

8. The thin linear motor kit according to claim 6, wherein the thin linear motor kit further comprises an adhesive layer, wherein the adhesive layer is disposed on the circuit mechanism, and the flexible circuit board of the coil module and the two end parts of the bottom plate are adhered on the adhesive layer.

9. The thin linear motor kit according to claim 1, wherein the support base is a covering member with an accommodation space, wherein an entrance of the accommodation recess faces downwardly, and the magnet module is fixed in the accommodation recess.

10. The thin linear motor kit according to claim 9, wherein one of the two swinging elements comprises two first elastic elements, the other of the two swinging elements comprises two second elastic elements, and each of the first elastic elements and the second elastic elements has a coupling end and a fixed end opposed to the coupling end, wherein the two first elastic elements and the two second elastic elements are respectively located at four corners of the accommodation recess, and each of the two first elastic elements and the two second elastic elements is connected with a top side of the accommodation recess through the corresponding coupling end.

11. The thin linear motor kit according to claim 10, wherein the thin linear motor kit further comprises a lower cover, wherein the lower cover is fixed on the circuit mechanism, and each of the first elastic elements and the second elastic elements is connected with the lower cover through the corresponding fixed end.

12. The thin linear motor kit according to claim 11, wherein the coil module is disposed on the lower cover.

13. The thin linear motor kit according to claim 12, wherein the coil module comprises a flexible circuit board and at least one coil, wherein the at least one coil is disposed on the flexible circuit board and faces the magnet module, and the flexible circuit board is attached on the lower cover.

14. The thin linear motor kit according to claim 11, wherein the thin linear motor kit further comprises an adhesive layer, wherein the adhesive layer is disposed on the circuit mechanism, and the lower cover is adhered on the adhesive layer.

15. The thin linear motor kit according to claim 10, wherein each of the first elastic elements and the second elastic elements is made of epoxy resin.

16. The thin linear motor kit according to claim 11, wherein the magnet module is a Halbach array magnet module, wherein the Halbach array magnet module comprises at least three permanent magnets, and the at least three permanent magnets are arranged along the first direction.
